(19) United States
(12) Patent Application Publication
(10) Pub. No.: US 2014/0220269 A1
(43) Pub. Date: Aug. 7, 2014

(54) COMPUTER WEBCAM LENS BLOCKER ASSEMBLY

(71) Applicant: ANTHONY OGUFERE OGUFERE, DUNWOODY, GA (US)

(72) Inventor: ANTHONY OGUFERE OGUFERE, DUNWOODY, GA (US)

(21) Appl. No.: 14/147,489

(22) Filed: Jan. 3, 2014

Related U.S. Application Data
(60) Provisional application No. 61/760,651, filed on Feb. 5, 2013.

(51) Int. Cl. B44C 5/00; H04N 5/225

(52) U.S. Cl. CPC B44C 5/005; H04N 5/2251
USPC 428/34.1

(57) ABSTRACT

A highly stable laptop computer webcam lens blocker assembly, which comprises of a selectively releasable clip or clasping sections and a fixed, clear insert holder with a pocket that is shaped to hold an insert-able medallion with indicia displayed on the, flat surfaces of the medallion. The display medallion is user selected with indicia that reflect the broadest possible varieties of individual and group preferences in art, style, fashion, moods, etc., as may be appreciated by users of consumer products. When the computer webcam is not in use, the lens blocker assembly may be clasped over the webcam lens on the screen side of a laptop computer, thus effectively blocking the lens and preventing unwanted or intrusive over-the-web viewing of a computer user by unauthorized persons. In a first embodiment, the insert-able display medallion allows for a small ridge on the crest of the medallion by which the display medallion may be held and inserted into, or withdrawn from, the pocket of the insert holder in a vertical action.

In an alternate embodiment the holding ridge is positioned further

### BACKGROUND TO THE INVENTION AND SUMMARY OF THE WEBCAM LENS BLOCKER ASSEMBLY

This invention relates to laptop computer webcam lens blocker, and more particularly to a highly stable, selectively releasable assembly with a pocket that holds an insert-able display medallion. The invention is useful in the age of increasing sophistication of hackers that are able to circumvent computer software security, remotely activate the computer webcam over-the-web, and effectively spy on or intrude on the privacy of a computer user.

The invention is also useful in that it satisfies user desire for a functional device that may also be personalized by selection of a display medallion that caters to individual taste, preference and/or group affiliation. The invention therefore offers satisfies webcam security requirements by way of the lens blocker, as well as caters to user requirement for personalization by way of the self-selected display medallion.

Prior Art

The prior art teaches webcam lens blocker of the type that allows the lens blocker device to slide over the top of the screen side of a laptop computer to achieve effective blocking of the webcam lens from intrusion. Many prior art lens blockers are made from hard plastic or other hard composite material, have fixed width or limited extensibility, and do not accommodate the range of screen-side thickness or thinness observable across the wide range of laptop models and brands.

Prior art lens blockers are also susceptible to sliding off the webcam lens, unbeknown to the user, thereby failing to protect the user from unauthorized over-the-web intrusion or breach of privacy.

Furthermore, due to the hard material used in prior art lens blockers, placement and removal of these lens blocker over time leaves abrasion that may damage webcam lens, or leave unsightly marks on the back surface of the laptop cover.

Moreover, prior art lens blockers are uniform in appearance and do not satisfy user preference for personalization, customization and group affinity that is highly valued by customers of consumer products.

Merits of Present Invention

The present invention is purposely designed to overcome above noted disadvantages in the prior art. The present invention's clasping sections enables the assembly to fit across the range of thickness and thinness observable in laptop computer screen sides. The lens blocker's clasping section prevents the assembly from inadvertently sliding off the webcam lens, thus achieving the primary objective of protecting the user from external breach of privacy and from over-the-web viewing through their webcam by unauthorized persons.

Moreover, the clasping sections are coated with soft material including gel, foam, fabric or other such material that would prevent abrasion of the webcam lens and screen back cover, during placement or removal of the lens blocker assembly.

Furthermore, the present invention includes an insert-able display medallion that may be selected by the user to reflect their preference for personalization, customization or group affinity. The insert-able display medallion allows user-selected variety and personalization in the broadest possible way through use of indicia, prints, logos, drawings, pictures, graphics, emblems, heirlooms, insignia, flags or other forms of art, imagery and rendering that enable distinguishing identification, distinction, customization or group affinity.

The insert-able display is designed with a holding ridge on the crest of the medallion that allows a user to conveniently insert and withdraw the medallion from the holding pocket in a top-to-down, vertical action. In this embodiment of the design, the entry into the pocket is situated on the top of the assembly. In an alternative embodiment, the holding ridge is situated further along from the crest of the medallion such that the insert and withdrawal of the medallion into the holding pocket may be achieved by sideways, horizontal action. In this alternative embodiment, entry to the holding pocket is situated on the side of the assembly.

Additional features and merits of the present invention and benefits from use of the webcam lens blocker will be more fully understood from the description of the drawings and preferred embodiments following, the claims that are herein appended thereto, and the drawings which are described below.

### DESCRIPTION OF DRAWINGS AND PREFERRED EMBODIMENTS OF THE PRESENT INVENTION

FIG. 1A is a perspective view of the webcam lens blocker assembly 10, releasably attached to the screen side 12 of a laptop computer which is connected to a docking station;

FIG. 1B is an exploded perspective view, similar to FIG. 1A, with the lens blocker assembly attached to block the lens of the laptop 14 and having an inserted display medallion 16 exploded away from the fixed, clear insert holder 18 attached to the lens blocker assembly;

FIG. 2A is an exploded perspective view and shows the back side of the lens blocker assembly with a pair of display medallion inserts 20, 26 exploded away from the pocket 24 of the fixed, clear insert holder 21; the clasping sections 22 of the lens blocker assembly is attached to a fragmentary screen portion of the laptop computer; the pair of display medallions show that it is intended for indicia to be displayed on the front side and backside of each medallion 20, 26; the display medallion has two extension ledges 23 which cooperates with the grooves of the pocket 25 to ensure stability of the display medallion while inserted in the pocket of the insert holder.

FIG. 2B is a perspective view, similar to FIG. 2A, intended to show that indicia on the display medallion will remain visible 29 while the medallion is inserted in the pocket of the clear insert holder; the small ridge 28 on the crest of the medallion enables a user to grip and withdraw the fully inserted medallion from the pocket of the insert holder, thus achieving a bottom-up withdrawal, or top-down insertion to replace medallion back into the pocket by vertical movement of the medallion. In an alternate embodiment, the ridge on the crest 27 will be featured on the side of the medallion, with afore-described medallion extension ledges 23 and clear pocket grooves 25 appropriately situated as to enable sideways insertion of the medallion into, or withdrawal from, the clear insert holder by horizontal movement of the medallion.

FIG. 3 is a side elevation of a prior art lens blocker;

FIGS. 4A and 4B are side elevations of the lens blocker completely closed 42 and completely open 46, respectively, to show the range of thickness of the computer screen that can be accommodated and held securely in a clasped position;

FIGS. 5A and 5B are side elevations of the lens blocker attached to the screen side of a laptop computer; the clasping sections of the lens blocker are lined with gel, soft foam or fabric 50, 52 to protect the lens side and back of the screen side of the computer from abrasion during clasping or release and removal of the lens blocker.

FIG. 6A is a perspective view of an alternate embodiment wherein the clear insert holder is attachable and detachable to the clasping clip via snaps to pivot pins which may have magnetizing properties for added stability with the clasping clip 62;

FIG. 6B is a perspective view of alternate embodiment of the insert holder exploded away from the clip with left and right pivot pin 64, 66 that cooperate with left and right snaps 67, 68;

FIG. 7A-C are side elevations of the alternate embodiment shown in FIGS. 6A & B that illustrate that the inserted display medallion can be selectively pivoted 76, 78 to a viewing angle convenient to the user.

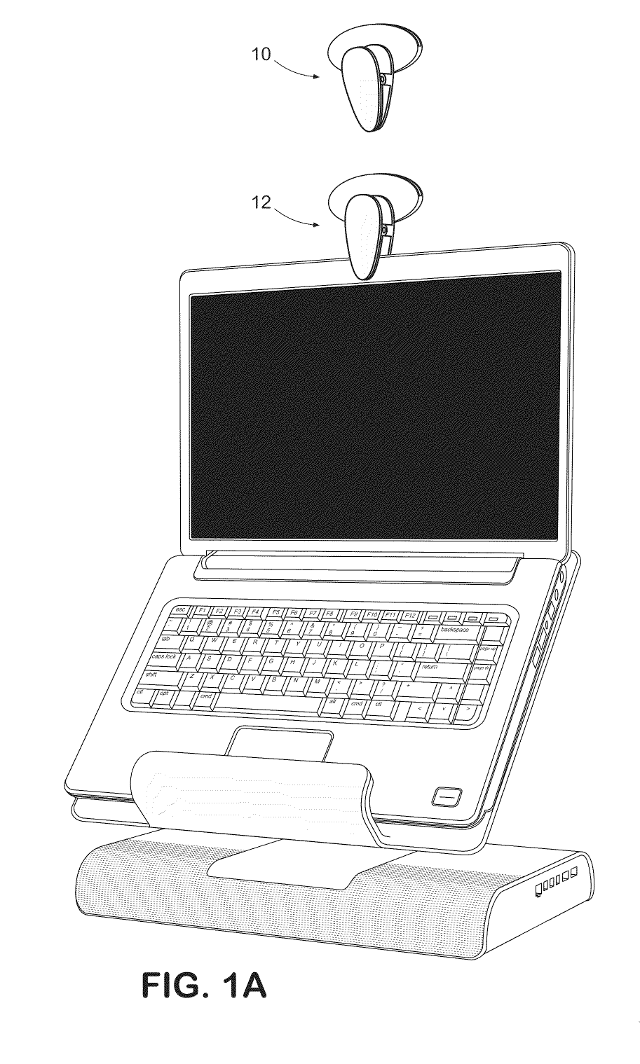

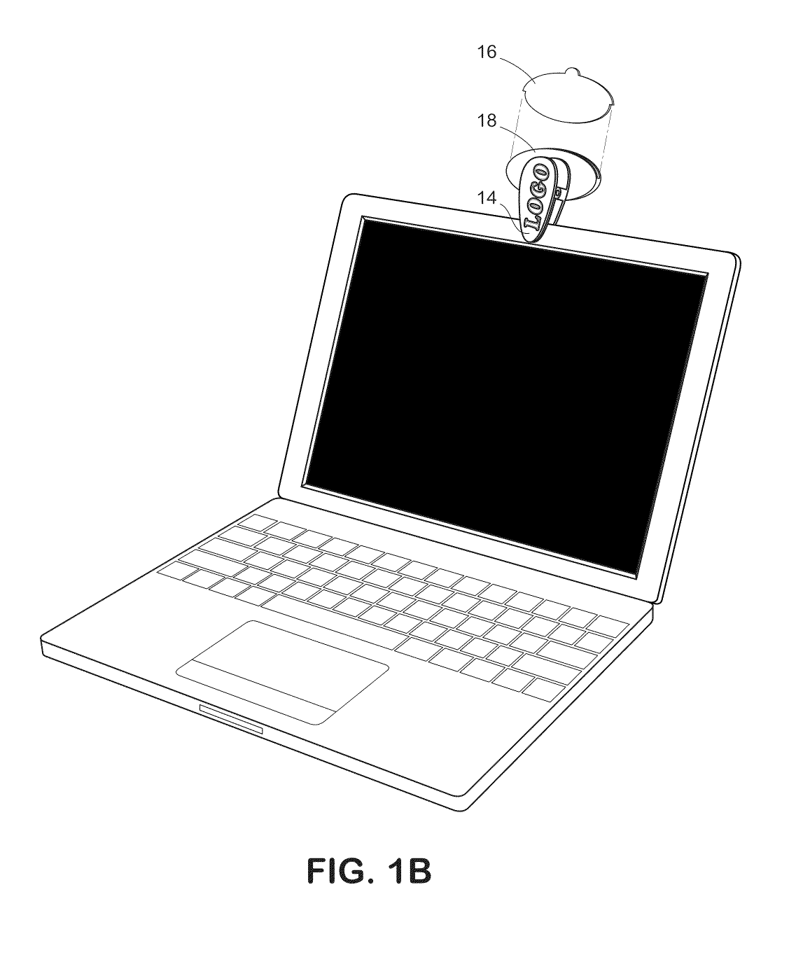

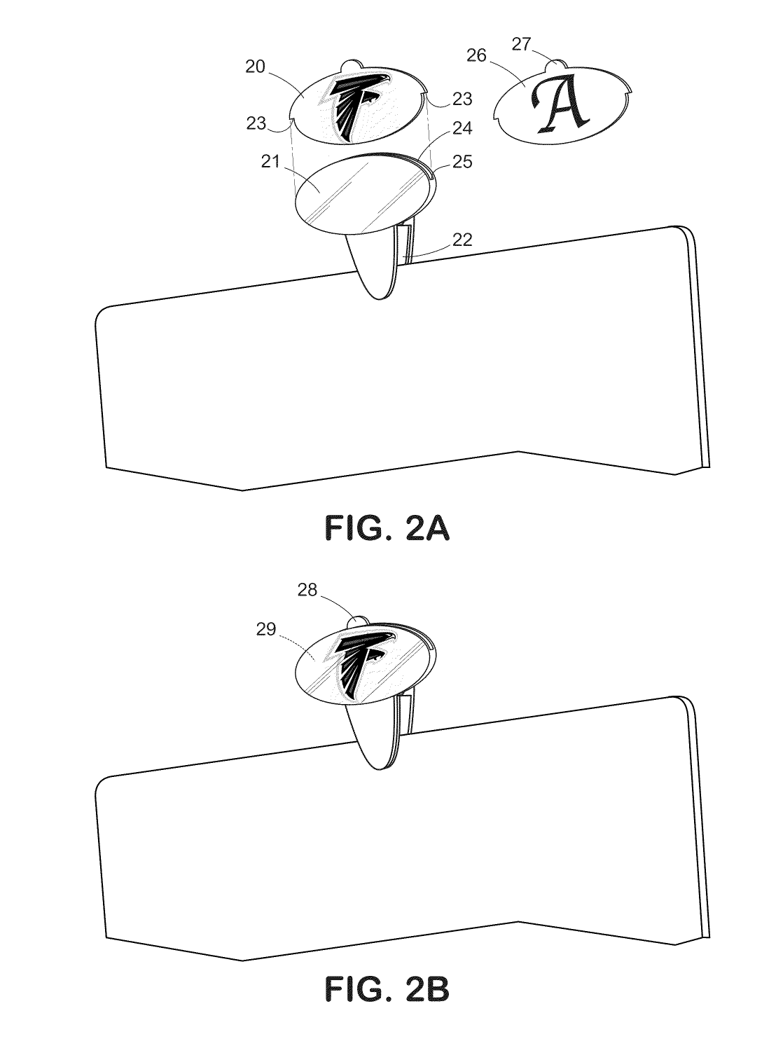

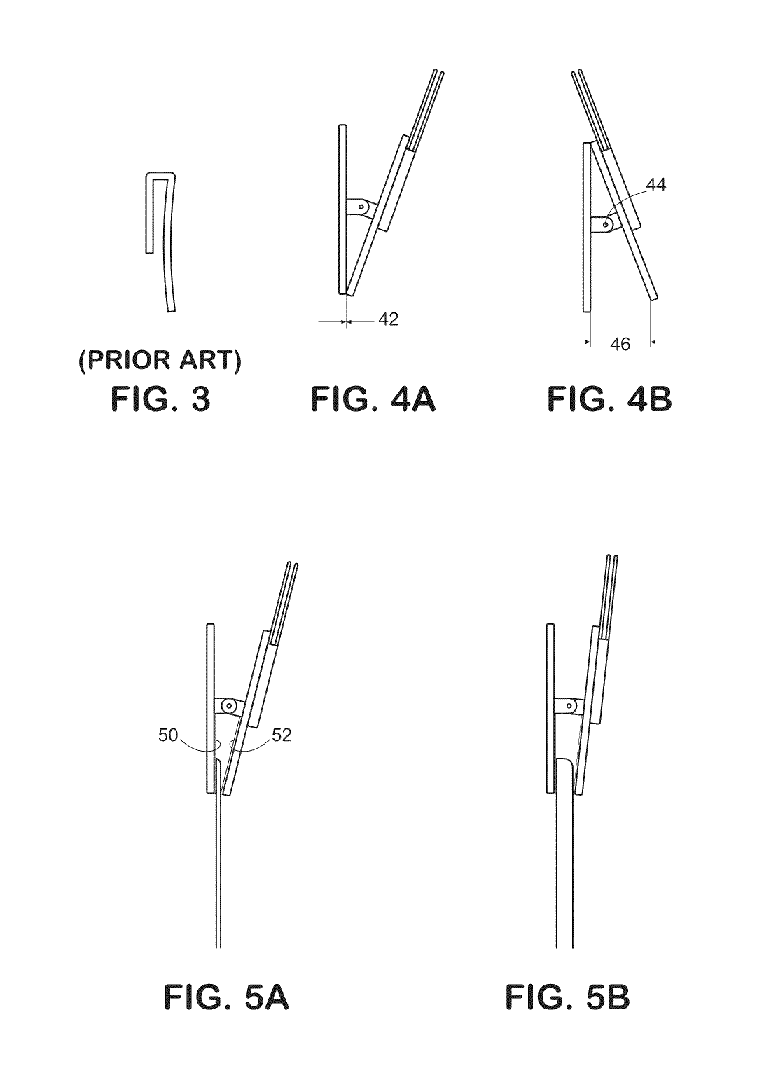

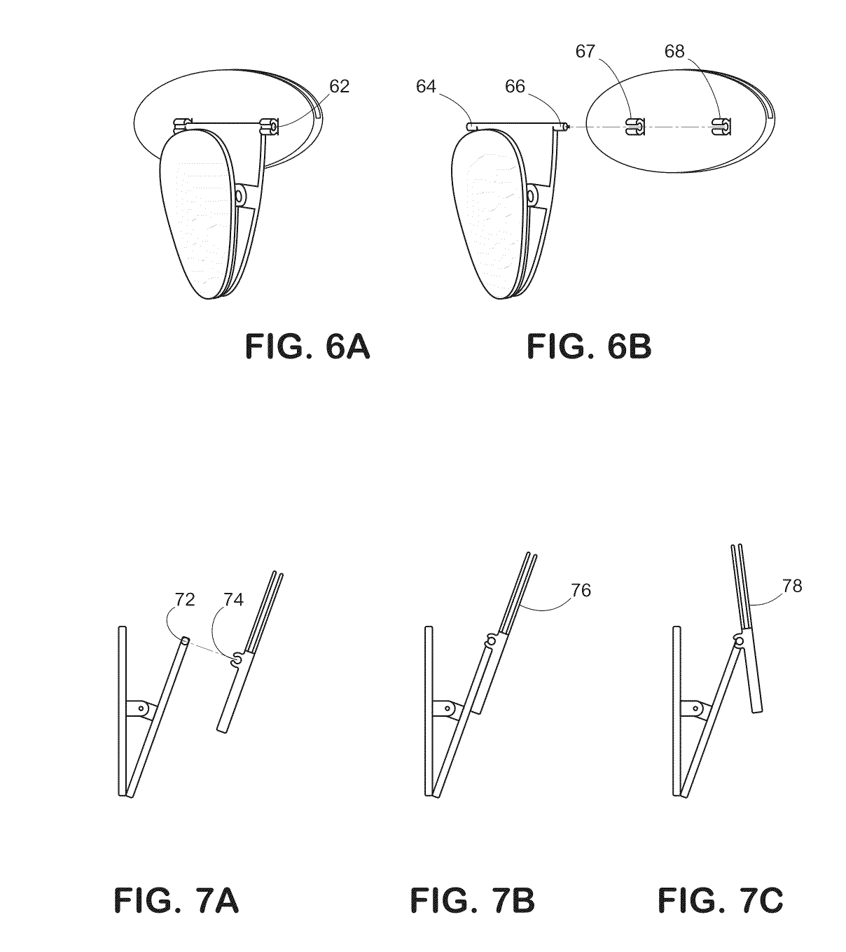

I claim:

1. A laptop computer webcam lens blocker assembly comprising a selectively releasable clip or clasping sections that covers the webcam lens from unauthorized viewing and an attached, clear insert holder with a pocket, shaped to hold an insert-able display medallion with indicia displayable on the surfaces of the medallion;

2. The webcam lens blocker assembly of 1 further including the attached, clear insert holder with the position of the pocket situated such as to insert and withdraw the insert-able medallion by top-to-down and bottom-to-up vertical action, or, as to enable insertion or withdrawal by sideways right-to-left and left-to-right, horizontal action;

3. The webcam lens blocker of 2 further including grooves on the edges of the insert holder pocket by which the display medallion may cooperate and ensure stability of the inserted medallion;

4. The webcam lens blocker of 3 further including the clip which is attachable via snaps to the pivot pins that allow user selective pivoting of the insert pocket holder and inserted medallion to a viewing angle that is of convenience to the user;

5. The webcam lens blocker assembly of 3 further including insert-able display medallion on the surfaces of the medallion with user-selected variety in the broadest possible terms by way of indicia, prints, logos, drawings, pictures, graphics, emblems, heirlooms, insignia, flags or other forms of art, imagery and rendering that enable personalization, identification, distinction, customization or group affinity.

6. The webcam lens blocker assembly of 5 further including extension ledges in the display medallion that cooperate with the grooves in the insert holder pocket and ensure the medallion remains stable when inserted in the pocket.

7. The webcam lens blocker assembly of 6 with a small ridge conveniently positioned on the crest or further along from the crest of the medallion, such that enables a user to grip the medallion and achieve convenient insertion or withdrawal of the medallion, either by top-down and bottom-up vertical action, where the pocket is situated on the top of the insert holder, or by sideways, horizontal action, where the pocket is situated on the side of the insert holder.
